(19) United States
(12) Patent Application Publication
(10) Pub. No.: US 2003/0163513 A1
(43) Pub. Date: Aug. 28, 2003

(54) Providing role-based views from business web portals

(75) Inventors: Thomas Schaeck, Achern (DE); Ajamu A. Wesley, Raleigh, NC (US)

Correspondence Address: Jeanine S. Ray-Yarletts, IBM Corporation T81/503, PO Box 12195, Research Triangle Park, NC, 27709, US

(73) Assignee: International Business Machines Corporation, Armonk, NY (US)

(21) Appl. No.: 10/081,300

(22) Filed: Feb. 22, 2002

(51) Int. Cl. G06F 15/16

(52) U.S. Cl. 709/201; 709/229

(57) ABSTRACT

Methods, systems, and computer program products are disclosed for providing role-specific views from a business web portal which supports one or more aggregated web services, where a “business web portal” is a collection of one or more portals which may be hosted by potentially disparate, autonomous service providers. This may be useful, for example, to extend the services of a particular business by programmatically including services of other enterprises. The disclosed techniques enable heterogeneous user profiles to be federated and exchanged in the dynamic, run-time web services integration environment. In this manner, users having particular roles can be programmatically presented with different views into an aggregated service. XML Linking language (“XLink”) is preferably used to associate role-specific views of a particular sub-service from the aggregation with the role(s) to which that view pertains.

### RELATED INVENTIONS

The present invention is related to the following commonly-assigned U.S. Patents, all of which were filed on Sep. 19, 2001: U.S. ______ (Ser. No. 09/955,788), “Building Disitributed Software Services as Aggregations of Other Services”; U.S. ______ (Ser. No. 09/956,268), “Programmatic Management of Software Resources in a Content Framework Environment”; and U.S. _______ (Ser. No. 09/956,276), “Dynamic, Real-Time Integration of Software Resources through Services of a Content Framework”. The present invention is also related to the following commonly-assigned U.S. Patent, which was filed on Jan. 15, 2002: U.S. ______ (Ser. No. 10/______), “Provisioning Aggregated Services in a Distributed Computing Environment”. These U.S. Patents are referred to herein as “the related inventions”, and are hereby incorporated herein by reference. The latter patent is referred to herein individually as “the provisioning invention”.

### BACKGROUND OF THE INVENTION

1.Field of the Invention

The present invention relates to computer software, and deals more particularly with techniques for providing role-based views from business web portals which aggregate network-accessible business processes and services in a distributed computing or networking environment.

2.Description of the Related Art

The popularity of distributed computing networks and network computing has increased tremendously in recent years, due in large part to growing business and consumer use of the public Internet and the subset thereof known as the “World Wide Web” (or simply “Web”). Other types of distributed computing networks, such as corporate intranets and extranets, are also increasingly popular. As solutions providers focus on delivering improved Web-based computing, many of the solutions which are developed are adaptable to other distributed computing environments. Thus, references herein to the Internet and Web are for purposes of illustration and not of limitation.

The early Internet served primarily as a distributed file system in which users could request delivery of already-generated static documents. In recent years, the trend has been to add more and more dynamic and personalized aspects into the content that is served to requesters. One area where this trend is evident is in the increasing popularity of content frameworks such as those commonly referred to as “portals” (or, equivalently, portal platforms, portal systems, or portal servers). A portal is a type of content framework which is designed to serve as a gateway, or focal point, for users to access an aggregation or collection of information and applications from many different sources. Portals are typically visual in nature, and provide their users with Web pages known as “portal pages”. A portal page is often structured as a single overview-style page (which may provide links for the user to navigate to more detailed information). Alternatively, portal pages may be designed using a notebook paradigm whereby multiple pages are available to the user upon selecting a tab for that page. Some experts predict that portal pages will become the computing “desktop” view of the future.

Another area where advances are being made regarding dynamic content is in the so-called “web services” initiative. This initiative is also commonly referred to as the “service-oriented architecture” for distributed computing. Web services are a rapidly emerging technology for distributed application integration in the Internet. In general, a “web service” is an interface that describes a collection of network-accessible operations. Web services fulfill a specific task or a set of tasks. They may work with one or more other web services in an interoperable manner to carry out their part of a complex work flow or a business transaction. For example, completing a complex purchase order transaction may require automated interaction between an order placement service (i.e. order placement software) at the ordering business and an order fulfillment service at one or more of its business partners.

Many industry experts consider the service-oriented web services initiative to be the next evolutionary phase of the Internet. With web services, distributed network access to software will become widely available for program-to-program operation, without requiring intervention from humans.

Web services are generally structured using a model in which an enterprise providing network-accessible services publishes the services to a network-accessible registry, and other enterprises needing services (or human beings searching for network-accessible services) are able to query the registry to learn of the services' availability. (Hereinafter, it should be assumed that references to an entity querying a registry include programmatic entities that are performing a search under direction of a human.) The participants in this computing model are commonly referred to as (1) service providers, (2) service requesters, and (3) service brokers. These participants, and the fundamental operations involved with exchanging messages between them, are illustrated in FIG. 1. The service providers 100 are the entities having services available, and the registry to which these services are published 110 is maintained by a service broker 120. The service requesters 150 are the entities needing services and querying 140 the service broker's registry. When a desired service is found using the registry, the service requester binds 130 to the located service provider in order to use the service. These operations are designed to occur programmatically, without requiring human intervention, such that a service requester can search for a particular service and make use of that service dynamically, at run-time. The web services model is theoretically available for any type of computing application.

Web services allow applications and services (referred to hereinafter as services for ease of reference) to interact with one another using web-based standards. The core set of standards on which web services work is being built includes HTTP (“Hypertext Transfer Protocol”), SOAP (“Simple Object Access Protocol”) and/or XML (“Extensible Markup Language”) Protocol, WSDL (“Web Services Description Language”), and UDDI (“Universal Description, Discovery, and Integration”). HTTP is commonly used to exchange messages over TCP/IP (“Transmission Control Protocol/Internet Protocol”) networks such as the Internet. SOAP is an XML-based protocol used to send messages for invoking methods in a distributed environment. XML Protocol is an evolving specification of the World Wide Web Consortium (“W3C”) for an application-layer transfer protocol that will enable application-to-application messaging, and may converge with SOAP. WSDL is an XML format for describing distributed network services. UDDI is an XML-based registry technique with which businesses may list their services and with which service requesters may find businesses providing particular services. (For more information on SOAP, refer to “Simple Object Access Protocol (SOAP) 1.1, W3C Note May 8, 2000”, which is available on the Internet at http://www.w3.org/TR/2000/NOTE-SOAP-20000508. See http://www.w3.org/2000/xp for more information on XML Protocol and the creation of an XML Protocol standard. The WSDL specification is titled “Web Services Description Language (WSDL) 1.1, W3C Note Mar. 15, 2001”, and may be found on the Internet at http://www.w3.org/TR/2001/NOTE-wsdl-20010315. For more information on UDDI, refer to the UDDI specification which is entitled “UDDI Version 2.0 API Specification, UDDI Open Draft Specification Jun. 8, 2001”, and which can be found on the Internet at http://www.uddi.org/specification.html. HTTP is described in Request For Comments (“RFC”) 2616 from the Internet Engineering Task Force, titled “Hypertext Transfer Protocol-HTTP/1.1” (June 1999).)

Application integration using these open standards requires several steps. The interface to a web service must be described, including the method name(s) with which the service is invoked, the method's input and output parameters and their data types, and so forth. WSDL documents provide this information, and are transmitted using a UDDI publish operation to a registry implemented according to the UDDI specification. Once the service is registered in the UDDI registry, service requesters can issue UDDI find requests to locate distributed services. A service requester locating a service in this manner then issues a UDDI bind request, which dynamically binds the requester to the located service using the service information from the WSDL document. (These UDDI operations have been illustrated, at a high level, in FIG. 1.) SOAP/XML Protocol and HTTP messages are commonly used for transmitting the WSDL documents and the UDDI requests. (Hereinafter, references to SOAP should be construed as referring equivalently to semantically similar aspects of XML Protocol. Furthermore, it should be noted that references herein to “HTTP” are intended in a generic sense to refer to HTTP-like functions. Some UDDI operations, for example, require HTTPS instead of HTTP, where HTTPS is a security-enhanced version of HTTP. These differences are not pertinent to the present invention, however, and thus no distinction is made hereinafter when discussing HTTP.)

The goal of web services is to provide service requesters with transparent access to program components which may reside in one or more remote locations, even though those components might run on different operating systems and be written in different programming languages than those of the requester.

While support for web services and portals continues to make great progress, areas remain where improvements can be made.

### SUMMARY OF THE INVENTION

An object of the present invention is to provide a technique for providing role-based views from business web portals (or similar content aggregation frameworks).

Another object of the present invention is to provide this technique in a manner that does not require end users to have programming skills.

A further object of the present invention is to define techniques for allowing various types of users to view aggregated web services in different ways, according to the role of a particular user.

Yet another object of the present invention is to define techniques for providing role-based views into services which may comprise aggregations of sub-services that span multiple enterprises.

Still another object of the present invention is to define techniques for federating, or joining, the roles associated with sub-services within an aggregated service to provide role-specific views into the aggregation.

Other objects and advantages of the present invention will be set forth in part in the description and in the drawings which follow and, in part, will be obvious from the description or may be learned by practice of the invention.

To achieve the foregoing objects, and in accordance with the purpose of the invention as broadly described herein, the present invention provides methods, systems, and computer program products for providing role-based views of aggregated services in a computing network. In preferred embodiments, the aggregated service comprises one or more software resources, and this technique comprises: providing a role-specific portlet for each role supported by a particular one of the one or more software resources; providing linkage between the role-specific portlets and the roles for the particular one of the software resources; repeating these two “providing” operations for each of the one or more software resources; obtaining, at run time, a user role corresponding to a user of the aggregated service; and using the obtained role to programmatically select a corresponding one of the role-specific portlets for each of the software resources, thereby providing the role-specific view of the aggregated service. The technique preferably further comprises rendering the selected role-specific view for the user.

Using the obtained role preferably further comprises: determining which of the one or more software resources should be invoked to position the user's entry point into the aggregated service; and using the obtained role to programmatically select a role-specific view of the determined software resource.

Preferably, the user role is stored in a user profile associated with the user, and the user role is determined using the user's identification and credentials.

The technique may further comprise programmatically relaying user role information (which may include additional user profile information) among distributed services performed by the software resources of the aggregated service. In this case, the programmatic relaying may comprise sending a message which specifies the user role in a header of the message and in which a body of the message identifies that this message is delivering the user role. The message is preferably a SOAP message.

The linkage preferably uses XML Linking language (“XLink”) syntax, and the linkage may be stored in a portlet archive (hereinafter, “PAR”) file.

Components other than portlets may be used alternatively.

The present invention will now be described with reference to the following drawings, in which like reference numbers denote the same element throughout.

### BRIEF DESCRIPTION OF THE DRAWINGS

FIG. 1 provides a diagram illustrating the participants and fundamental operations of a service-oriented architecture, according to the prior art;

FIG. 2 illustrates use of the present invention to provide multiple views of an aggregated web service to users having different roles;

FIG. 3 is a block diagram illustrating a portlet structured as a web service proxy, according to preferred embodiments of the related inventions;

FIG. 4 provides an illustration of the web services stack approach to service aggregation, as disclosed in the related inventions;

FIG. 6 provides a sample file containing linking statements that may be used to map role-specific views to portlets, according to preferred embodiments of tile present invention; and

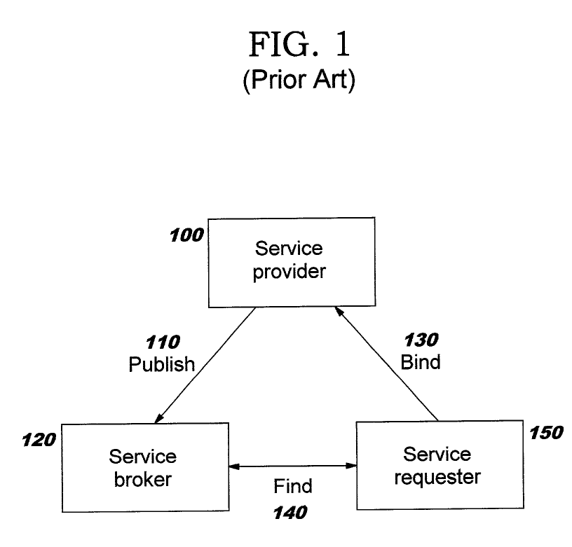

FIGS. 5 and 7 provide flowcharts depicting logic which may be used to implement preferred embodiments of the present invention.

### DESCRIPTION OF PREFERRED EMBODIMENTS

The present invention discloses techniques enabling one or more distributed portals, aggregated as a single “virtual enterprise” portal, may provide multiple views to participants in a web-accessible value chain, where those views are a function of the participant's role. The distributed portals may be from disparate, autonomous sources. The disclosed techniques leverage federated profile exchange, web services, and a number of industry standards, as will be described.

The related inventions disclosed (inter alia) techniques for aggregating web services using a content framework which is referred to herein as being a portal, such that the portal provides an entry-point into the aggregated service. Portal software has undergone an evolution from its original platform, which offered aggregated visual services for consumers, to become a platform or framework for providing aggregated visual and programmatic services for both consumer and enterprise applications.

The enterprise applications and services which may be accessed from portals may integrate with so-called “front office” and “back office” functions. (“Front office” functions are those with which customers and end users typically interact, or which are designed to support interaction with these users, such as order entry applications, customer relationship management software, etc. “Back office” functions are those which typically support an enterprise's operations, such as payroll, purchasing, inventory, billing, and accounting.) This evolution is evidenced by the emergence of software solutions which integrate with portal software, offered by the leading enterprise application vendors.

As an example of this type of integrated or aggregated service, a portal may provide access to a shopping service, where this shopping service comprises a number of sub-services such as accessing an electronic catalog, processing end-user orders, checking a person's credit status, managing delivery of orders to consumers, and so forth. The sub-services in this list may be readily adaptable to support the end-user's shopping experience. The shopping service may be considered as an example of front office functions (although some of the supporting sub-services, such as credit checking, are typically considered to be back office functions). The aggregated shopping service may also include sub-services that support the retailer's business, as well as the businesses of the retailer's trading partners. For example, the shopping service may include a sub-service that automatically places an order with a wholesaler when the retailer's inventory levels reach a particular threshold, another sub-service that processes payments between the retailer and its trading partners, etc. These are examples of back office functions.

The term “service” as used hereinafter is intended to refer to a composite service, as well as to the sub-services which have been aggregated to form that composite service. The term is also intended to encompass varying types of business applications and processes. The term “portal”, as used herein, is intended to include other types of frameworks which provide aggregations of content and/or services, and the term “portlet” is used in an illustrative sense and includes component implementations which adhere to component models other than the portlet model used in preferred embodiments.

Just as enterprises will be leveraging traditional enterprise portals to publish the enterprise's services, it is anticipated that collaborating businesses will leverage business web portals to publish business processes which may span their respective enterprises. The term “business web portal”, as the term is used herein, refers to a collection of portals hosted by potentially varying service providers which provides a visual representation of a set of integrated business processes which span these service providers. A work flow model is preferably used to define the aggregation of business processes and services. Use of work flow models in enterprise portals was described in the related inventions. (Preferred embodiments of the related inventions use the Web Services Flow Language, or “WSFL”, for expressing a work flow, and a WSFL engine for supporting that markup description, as described therein.) The work flow technique applies equally to the business web portals disclosed herein.

Use of these inter-enterprise aggregations enables a business to offer a “virtual enterprise” from a portal, wherein a particular business's services may be extended by programmatically including services of other enterprises (thus offering a more functionally rich solution). This virtual enterprise is also referred to herein as a “value chain” or a “business web”, and a collection of portals from which these types of services are available is referred to herein as a “business web portal”. (It should be noted that the business web portal may provide a collection or aggregation of potentially autonomous portal deployments.) In the shopping service, for example, the retailer might include services of a credit card company or bank to perform the credit checking function, and might access a delivery company's service for handling order delivery, rather than the retailer providing its own credit checking and delivery processes. This approach allows a business to increase its web presence without a corresponding increase in integration costs.

Furthermore, it is anticipated that the services in a business web will be “pluggable”; that is, the provider of a particular service may be changed dynamically, without requiring the composite service to be redefined or reinstalled. In the general case, any of the participants in a value chain may change from time to time, as participants enter and leave the business web community. (It should be noted that one of the principal participants in the value chain is the end-user or consumer.)

Different service providers may publish their web services into the business web portal. Suppose, for example, that an on-line shopping service is to be provided. This on-line shopping service may comprise sub-services such as a buying web service, a billing web service, a delivery web service, a credit check web service, customer case services, and so forth. Multiple service providers might be available for each of these types of service. A virtual enterprise can then be created by selecting among the sub-services and/or by selecting individual ones of the service providers.

The services provided within a value chain may vary widely. Examples of services that might be included in a value chain include sales force automation, customer relationship management, order management, payment processing, supply chain automation, fulfillment/distribution, and more. When the aggregated services are from disparate sources, providing a seamless integration of the sub-services presents a number of challenges.

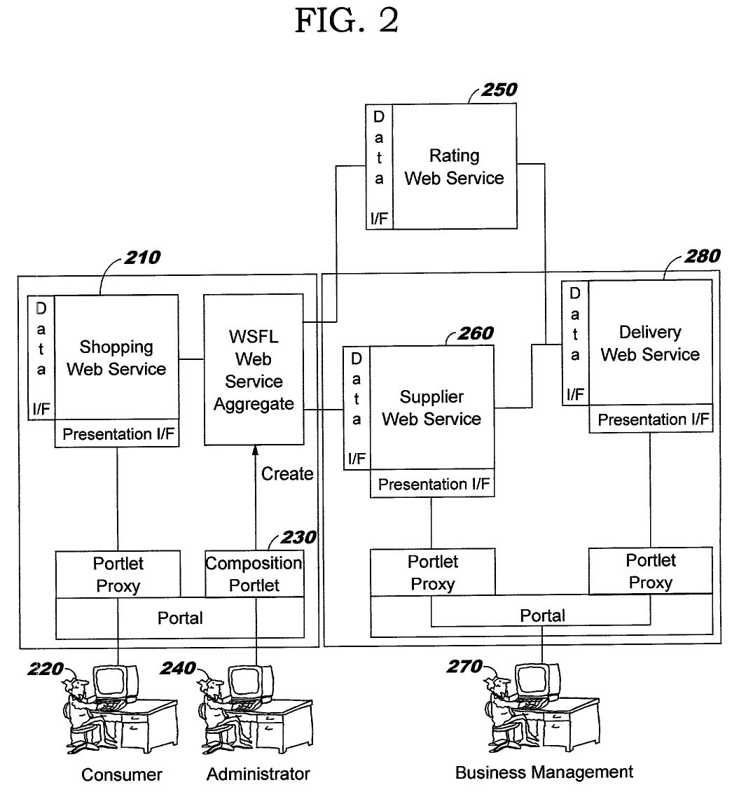

It is expected by the present inventors that significant advantages can be realized by providing role-specific views into the value chains, where the multiple views will be based on the services and/or information which are relevant to a particular role. The present invention is directed toward providing these role-specific views for aggregated services. It will be appreciated by those familiar with the art that participants may be authenticated by disparate security systems which are not managed by a central authority. Thus, it is assumed that both authentication and credential acquisition occurs in a federated manner. Referring again to the shopping example, along with the illustration provided in FIG. 2, users 240 who have the role of administrator might be allowed to create a composite shopping service, and to add or delete services from the composite service. For example, the administrator might add a customer feedback sub-service (not shown in FIG. 2). Users 220 who have the role of consumer, on the other hand, might be provided a view which limits them to browsing items which can be purchased and placing orders—and which perhaps gives them access to information about their previously-placed orders. Users 270 with a role such as “business management” might be allowed to make various types of changes to the composite service (or to its sub-services), such as selecting the providers of the sub-services, changing prices of items offered for sale, modifying delivery agreements or other types of trading partner agreements, and so forth.

FIG. 2 also illustrates the concept of visual “user-facing” web services. (That is, these web services have user interaction, such as presenting data to a user and processing events in response to user actions.) Whereas many web services are limited to a data-oriented interface, and supply their output as a markup stream that will be rendered by presentation services of the portal, web services (which, in preferred embodiments, are implemented using a portlet model) in a value chain may have both a data-oriented interface and a user-facing, or presentation, interface. A data-oriented interface is used for communicating among programmatic entities. A presentation interface is used for interacting with a human user. Thus, shopping web service 210 is shown as having both types of interface, where a consumer 220 is depicted as interacting with the presentation interface. (The shopping web service 210 as shown in FIG. 2 is a sub-service of a composite service which supports the shopping process, where the composite service in this example also includes services 250, 260, and 270.) The supplier web service 260 and delivery web service 280 are also depicted as having both types of interface, and thus business management user 270 may use the presentation interface of these components to perform changes such as those which have been described above. Credit rating web service 250, on the other hand, does not have a presentation interface in this example. Assuming that this rating service 250 provides credit checking, its interactions might be designed to occur only in a programmatic manner, and not to allow user input; in this case, no presentation interface would be provided.

FIG. 2 also illustrates use of “portlet proxies” which are bound to a visual, user-facing web service to enable that visual web service to interact with a portal. Generic portlet proxies were described in the related inventions. A composition portlet 230 is depicted, with which an administrator 240 preferably creates/modifies the work flow definition of an aggregated web service. Preferably, this composition portlet displays a selection of web services and allows the administrator to describe how selected services will interact. The related inventions described a tool which may be used for this purpose in enterprise portals; this tool may also be used in the business web portal environment.

As will be obvious once the teachings of the present invention are known, there may be significant advantages to providing different views of a particular service to users in different roles. In addition, there may be many business webs for which users in particular roles should not have access to the full set of functionality. For example, the consumer should not normally be allowed to plug in a different credit rating service 250, or to redefine the composite shopping service to eliminate the credit rating service. Similarly, it may be advantageous to limit access to functionality for other types of users, or to otherwise alter the view which different users receive. For example, suppose a composite shopping service includes as participants an on-line retailer, a vendor of the retailer (whose products are sold by the retailer using the online retailer's web presence), a delivery company, and a consumer. Further suppose that, when accessing the business web portal, the consumer and the vendor are both provided views of the on-line retailer's inventory management business process. However, the consumer will see product availability information, whereas the vendor will see aggregate inventory information that informs this vendor whether it needs to replenish its products in the on-line retailer's inventories. The present invention therefore defines techniques for providing these types of role-specific views of business webs. (While discussions herein are primarily in terms of views that are role-specific, additional criteria may be used in an optional aspect of the present invention to tailor a user's view, such as user preferences, and support for this optional aspect may be added to an implementation of the present invention.)

To provide role-based views for business webs which may integrate services from a number of different sources, it is necessary to be able to automatically and dynamically “federate” or join the heterogeneous user profile information they may use. The exchange of profile information must be done in real time so that user roles can be seamlessly determined, and an appropriate view can be presented which aggregates content appropriate for that role. Furthermore, it is desirable to provide this user profile information using a single sign-on approach, whereby identifying information obtained when a user begins to use a portal can be programmatically obtained and used by sub-services of an aggregated service, because requiring users to identify themselves repeatedly during the course of a particular service would likely cause user frustration and would be time-consuming and inefficient. The present invention provides a solution for these requirements, and leverages a number of open industry standard technologies in doing so, as will be described.

As used herein, the term “federated profile exchange” refers to a process whereby a federation authentication of an end user is performed (as disclosed in the provisioning invention); security attributes (such as the user's role) which are relevant for authorization are acquired, for this authenticated user; and profile data associated with these security attributes is resolved.

Before discussing further details of the present invention, it is helpful to review a bit of background information, including the technologies on which preferred embodiments of the invention are built. The related inventions defined techniques for managing web services and for providing an aggregation point where services can be aggregated to form new services which can their be deployed. Preferred embodiments of the related inventions are built upon a content framework such as a portal platform, because this type of framework provides many built-in services for content management and service hosting, such as persistence, personalization, and transcoding. The techniques disclosed in the related inventions extend the platforms to provide for aggregation, deployment, management, and provisioning of web services. A modeling composition tool was disclosed, which may be used to define an aggregated service; software resources can then be programmatically integrated according to this aggregated service definition. In addition, the aggregated services can be managed in an automated manner.

The present invention defines techniques for providing role-based views into business web portals, where the business web portals may be created as composite or aggregate services as disclosed in the related inventions. These role-based view techniques may also be adapted to aggregations of services which are created in other ways, without deviating from the scope of the present invention. Furthermore, it should be noted that while discussions herein are in terms of providing role-based views into “aggregated” services, an aggregated service is itself a web service (comprised of sub-services), and therefore the present invention may be used advantageously with those web services which may be considered as atomic services (and are therefore a degenerate case of aggregation where the set of aggregated “sub-services” has a single member).

One commercially-available portal platform on which the present invention (as well as the related inventions) may be implemented is the WebSphere® Portal Server (“WPS”) from the International Business Machines Corporation (“IBM”). (“WebSphere” is a registered trademark of IBM.) Note, however, that while discussions of the related inventions and present invention are in terms of a portal platform, the inventive concepts are applicable to other types of content frameworks which provide analogous functionality and are also applicable to portals other than WPS, and thus references to portals and their portlet paradigm is by way of illustration and not of limitation.

The dynamic run-time integration of web services which is made possible by the related inventions may use a composition tool for aggregating new web services. Using this composition tool, a systems administrator (or, equivalently, a service composer or other person) may define a new service composed of more fine-grained services. The fine-grained services from which other services are built may reside locally or remotely, and the techniques of the related inventions enable referencing those services and using those services in a transparent manner without regard to whether they are local or remote. The fine-grained services may include any form of programming logic, including script programs, Java™ classes, COM classes, EJBs (“Enterprise JavaBeans”™), stored procedures, IMS or other database transactions, legacy applications, and so forth. (“Java” and “Enterprise JavaBeans” are trademarks of Sun Microsystems, Inc.) The web services created in this manner can then automatically be managed by the portal platform and can also be used in creating new web services in a recursive manner, as was described in the related inventions.

The related inventions leverage portlets as a portal interface, and also build upon the concept of a remote portlet interface (where this concept is extended to apply to programmatic portlets), to enable access to software resources. Portlets functioning in this manner may be referred to as “web service intermediaries” or “web service proxies”. That is, the related inventions enable a portlet to act as an intermediary between an application or software resource requesting a particular service and a software resource providing that service. The software resource performing a particular function may be statically bound to a web service proxy (for example, at development time), or a web service proxy may be bound to a software resource which is dynamically selected (for example, based upon criteria which are evaluated at run-time). In either case, the portlet proxy receives request messages and forwards them to the software resource to which it is bound; once the software resource has completed the requested function, it returns its response to the portlet proxy which then forwards the response to the requester.

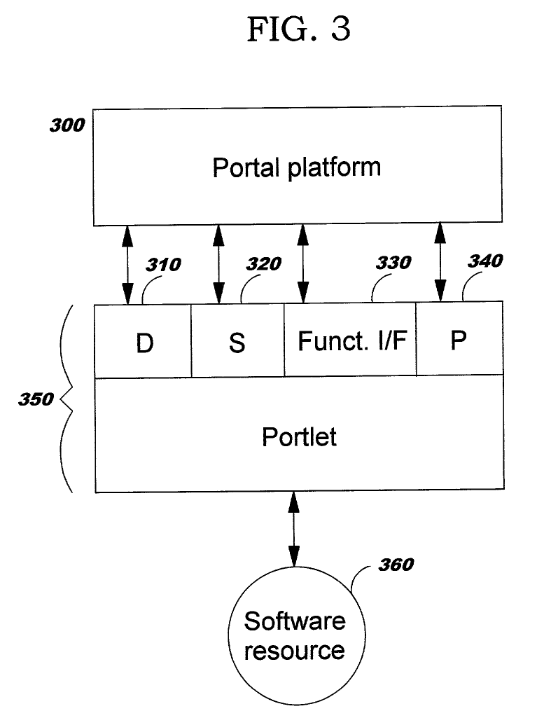

A block diagram illustrating a portlet structured as a web service proxy, according to the related inventions, is shown in FIG. 3. As shown therein, portlet proxy 350 includes a deployment interface 310, a system interface 320, and a functional interface 330. Portlet proxy 350 also preferably includes a provisioning interface 340. The portlet proxy communicates with a portal platform 300 using these interfaces, acting as an intermediary between the portal platform and the software resource 360 which carries out the function of interest. Details of each functional interface are specific to the web service provided by software resource 360, and do not form part of the related inventions. The related inventions, however, make the functional interface of the software resource 360 available as an interface 330 of the portlet proxy. (Exposing the functional interface using WSDL definitions and SOAP services may be accomplished using a commercially-available tool such as the IBM Web Services Toolkit, or “WSTK”, during the deployment process, as was discussed in the related inventions.)

It should also be noted that, while preferred embodiments of the present invention preferably provide the deployment and system interfaces as well as the provisioning interface, alternative embodiments may omit one or more of these interfaces without deviating from the scope of the present invention.

The deployment, system, and provisioning interfaces are described in detail in the related inventions. A brief summary will now be provided. According to preferred embodiments of the related inventions, a deployment interface and a system interface are defined for each portlet which serves as a web service proxy (although in alternative embodiments, one or the other of these interfaces may be implemented). These interfaces may also be referred to as the deployment port type and system port type, respectively. A provisioning interface may also be defined. A portlet according to the related inventions thus defines a service provider type that includes the port types necessary for portal integration of software resources and service interaction and management, and when a provisioning interface is provided, for provisioning a service to be integrated in a portal. (“Port types” is a term used in the art to signify the specification of a portlet's operations, and “service provider type” is a term used to signify a collection of port types.)

The deployment interface enables a portlet proxy (that is, an aggregated web service which is represented by a portlet proxy) to be used in subsequent web service composition operations, in a recursive manner, according to the related inventions. For example, the deployment interface of a portlet “A” provides information about portlet A for use as portlet A is aggregated with other portlets to form a new web service “Z”. By defining a deployment interface for web service Z, according to the related inventions, information about web service Z can subsequently be provided as service Z is used for composing other new services.

The system interface is used for run-time management of portlets (that is, of web services represented by portlet proxies) by the portal platform. Use of the system interface allows the portal platform to perform functions such as logging of events, billing, and other types of administrative operations pertaining to execution of the web service. Two-way communication between the portal platform and the portlet proxy is used for this purpose.

The provisioning interface disclosed in the provisioning invention enables automatically and dynamically federating the heterogeneous identity systems which may be in use among the services which are aggregated as a composite service. The techniques disclosed therein allow users (whether human or programmatic) to be seamlessly authenticated and authorized, or “identified”, for using the dynamically-integrated services. This seamless identification may be provided using a single sign-on, or “unified login”, for an aggregated service, wherein the provisioning interface of the aggregated service can be used to solicit all required information from a user at the outset of executing the aggregated service. (However, it may happen that some information needs to be requested from the user during execution, and in this case, use of the provisioning invention enables minimizing such requests.) A “stacking” approach was described whereby user passwords (or other credentials, equivalently, such as tickets or digital certificates) to be provided to the sub-services of an aggregated service are encrypted for securely storing. The sub-services are invoked in a specified order during execution, according to the WSFL definition, and the stacked passwords are then unstacked and presented to the appropriate authentication or authorization sub-service.

According to the related inventions, WSDL documents are preferably used to provide the deployment, system, and provisioning interface specifications. By representing the port types (i.e. interfaces) as WSDL documents, as disclosed in the related inventions, the deployment, system, and provisioning information for a web service can then be programmatically registered in a registry, and information about the interfaces can be located and bound to programmatically at run time. (Refer to the related inventions for a detailed description of these interfaces and illustrations of corresponding WSDL documents.)

As discussed in the related inventions, creating a WSDL document may be performed by a human user or using programmatic operations, or a combination thereof. For example, the human user might may be asked to supply information such as the port type name, the location of the name space information, and so forth, while programmatic operations generate <operation> and <message> elements for a software resource's public methods. IBM's WSTK is an example of a commercially-available product which may be used to programmatically generate WSDL for an existing software resource. See “The Web services (r)evolution: Part 4, Web Services Description Language (WSDL)”, G. Glass (February 2001), published by IBM on the Internet at http://www-106.ibm.com/developerworks/webservices/library/ws-peer4, which presents an example of programmatically generating a WSDL document for a simple weather service which has “getTemp” and “setTemp” operations.

As disclosed in the related inventions, a directed graph is preferably used to model the operations involved in executing aggregated web services comprised of other web services (i.e. sub-services). Selected portlet operations represent the nodes of the graph, and the graph edges which link the nodes represent potential transitions from one service operation or process to another. These service links can be qualified with one or more transition conditions, and also with data mapping information if applicable. The conditions specify under what conditions the next linked service should be invoked. Often, these conditions will be determined using the results of a previous service invocation. Data mapping refers to the ability to link operations between portlet port types and transfer data from one operation to another. For example, the data mapping information may indicate that the output parameters of one service are mapped to the input parameters of another service.

Preferably, WSFL is leveraged for this directed graph support. In particular, WSFL's persistent storage techniques and run-time evaluation techniques using directed graphs may be added to a web services stack to operate upon the graphs created by a service composer. For a detailed discussion of WSFL, refer to the WSFL specification, which is entitled “Web Services Flow Language (WSFL 1.0)”, Prof. Dr. F. Leymann (May 2001), available on the Internet from IBM at http://www-4.ibm.com/software/solutions/webservices/pdfWSFL.pdf, which is hereby incorporated herein by reference as if set forth fully.

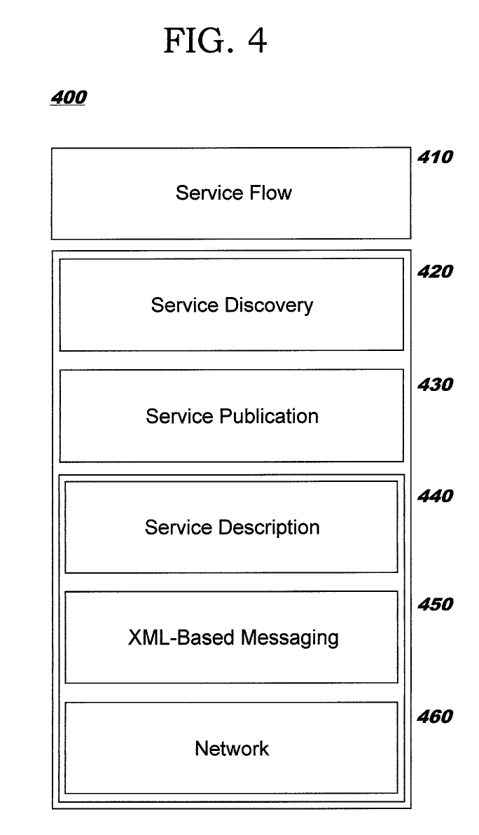

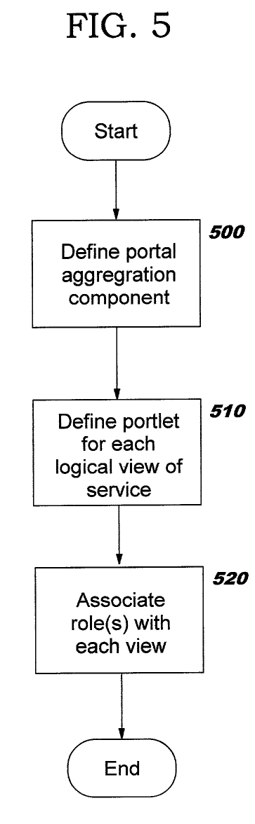

Refer to FIG. 4 for an illustration of the web services stack approach to service aggregation as disclosed in the related inventions. The web services stack 400 preferably uses WSFL service flow support 410 for defining and executing aggregated services, and service discovery 420 and service publication 430 are preferably provided using UDDI. The web services stack also comprises a WSDL layer 440 to support service description documents. SOAP may be used to provide XML-based messaging 450. Protocols such as HTTP, File Transfer Protocol (“FTP”), e-mail, message queuing (“MQ”), and so forth may be used for network support 460. As discussed in the related inventions, WSDL is used to define web service port types and to define how to invoke operations of these port types, and WSFL is used to aggregate the web services (and therefore to aggregate their interfaces). At run-time, services are found within a registry using the UDDI service discovery process, and bound to using information from their WSDL definitions. The WSFL run-time then uses these (port type) definitions to aggregate the services. (Because the signatures of the operations will typically not match one-to-one, a “plug link” mechanism defined in the WSFL specification can be used in a proxy model to map interfaces in a simple manner as described in the related inventions, thereby providing a correspondence between operation interfaces. The related inventions disclose using this plug link mechanism as the persistent definition of integrating portlet proxies to implement web services.)

The techniques disclosed in the provisioning invention address the difficulty of providing unified authentication and authorization by enabling an aggregated service to be provisioned within the context of a web services work flow, where operations are identified using WSDL documents and are invoked using SOAP messages within a work flow definition.

The provisioning invention discussed the fact that aggregated services may constrain access to their exposed operations to those users who have sufficient credentials, and who successfully demonstrate these credentials using an exposed authorization operation. The provisioning invention also stated that it may be advantageous to enable creation of user profiles which span an aggregated service, and optionally to allow these user profiles to be queried, changed, and/or deleted using corresponding service operations of the provisioning interface. The aggregated service may also be configured using information obtained with the provisioning interface, as stated therein, and user profiles may include user access rights information. One use of user rights which was briefly discussed in the provisioning invention is to determine the user's operation-specific authorization. For example, users may have a number of roles which determine their credentials for a specific class of operations. A person who is a manager might be allowed to view the personnel records of his employees when acting in his manager role, as one example, whereas he might not be allowed to use this same operation to see his own personnel record when acting in his role of an employee. The discussion of views based on roles was limited to this data-specific access-restriction example, and did not describe providing different views into a business web for users having different roles.

Preferred embodiments of the present invention build on this concept, and extend the role-based processing in order to provide multiple views into a business web, according to the present invention. In preferred embodiments, the specification of the role that corresponds to the user's current log-on status is stored as an attribute of the user's profile. For example, when a systems administrator logs on with his/her administrative identifier and password, these values will preferably identify a user profile where the user's role is “admin” (or some semantic equivalent). If this same person logs on with another identifier, such as a regular employee identifier, then that identifier and password preferably identify a different user profile record having a different user role. The user's profile is preferably accessed using the provisioning interface. (In alternative embodiments, the role information may be stored elsewhere, and/or may be accessed using methods provided in an interface other than the provisioning interface, including a dedicated “Roles” interface.)

A developer who creates the source code for a software resource to be deployed as a web service is responsible for specifying methods which implement the role-specific views of that service. The services may then be aggregated as described in the related inventions, and the techniques of the present invention may be used for selectively invoking the role-specific views, based on the programmatically-determined role of a particular user. For example, with reference to the shopping service which was previously discussed, a user who has a “consumer” role may be presented with a view into a retail shopping service, where this view might begin (as one example) by showing graphic images of featured sale items. Alternatively, a default role might provide this type of entry point. That is, if specialized views into the shopping service are defined for users in the “administrator” role and perhaps for users in the “business management” role, then any users not in either of these roles would receive the default view.

One or more of the sub-services which are aggregated to create a composite service may have methods that are designed for users in particular roles. When the sub-services are aggregated, it becomes necessary to seamlessly integrate the handling of user roles, and to provide a view of the aggregated service which properly reflects the user's role across the set of sub-services.

Typically, information about the roles of users is stored in identity systems or credential acquisition services along with other identity information (such as user identifiers, passwords, and configuration preferences). Thus, references hereinafter to obtaining information about roles is described with reference to identity systems, although in particular implementations this role information may be stored elsewhere (such as in a dedicated role repository).

The provisioning invention discussed publishing each sub-service's provisioning interface to a UDDI registry using a WSDL document, thereby enabling the joining of identity systems for (sub-)services which are dynamically integrated. The provisioning invention also stated that the provisioning interface of the aggregated service can then be created by manually or programmatically selecting from the interfaces of the sub-services comprising the aggregation, and a WSDL document may be created for this new provisioning interface and published, in a recursive manner. The present invention extends this teaching to encompass authorization-relevant attributes, and thus facilitates programmatic location of, and binding to, a role-based view into dynamically integrated distributed services. As in the provisioning invention, this functionality is provided within the context of a web services work flow, where operations are identified using WSDL documents and are invoked using SOAP messages within a work flow definition.

The manner in which this support may be implemented in preferred embodiments will now be described with reference to the flowchart in FIGS. X and Y. The logic in FIG. x shows how the role-based support for an aggregated service may be initialized, and the logic in FIG. y shows how a role-based view may then be provided for a user at run time.

Beginning at Block 500 of FIG. 5, a “portal aggregation component” is defined. A portal aggregation component, as the term is used herein, refers to a component which is aware of multiple versions of a particular service, where those versions are provided (in preferred embodiments) using a portlet model. Preferred embodiments leverage a portal aggregation plug-in for this purpose, which dynamically aggregates page content (i.e. portlets to place on a page.) In the case of the present invention, for example, suppose an inventory service has an interface for users having a role such as “inventory clerk”, where this interface allows the user to modify the count of how many of each part are currently in inventory. This inventory service may have another interface for users in the role of “inventory administrators”, where users in this role are allowed the modify the list of parts which are in the inventory (and are also allowed to modify the inventory counts). Another interface, from which users can only view on-hand inventory information but cannot make any changes, might be provided for users in all other roles. Thus, depending on the role of a particular user, the corresponding interface needs to be made available at run-time. According to preferred embodiments, Block 510 defines a separate portlet for each of these different (logical) views of the service. Thus, in the inventory example, three role-specific portlets will be defined. The number of portlets which are to be defined in a particular instance is determined by the person or entity defining the aggregation according to FIG. 5, and will vary based on the underlying services and the different role-based views which are supported by those services.

Blocks 500 and 510 therefore expose services and business processes as portlets having a presentation interface, in addition to their prior art transaction-oriented or data-oriented interfaces. This is preferably achieved by leveraging the Portlet API of the prior art, whereby each of the defined portlets supports the methods of the Portlet API and thus has a visual aspect. (For an explanation of how multiple transaction-oriented interfaces into an individual, non-aggregated service can be provided as different views using mode indicators—such as whether the portlet is being invoked in Help mode, Configuration mode, Edit mode, or normal View mode—using prior art techniques, see “Introduction to portlet structure and programming”, D. Lection, which was published by IBM on the Internet at location http://www-106.ibm.com/developerworks/library/i-portal (November 2001).)

The role-specific portlets which are defined may be hosted remotely from the portal server, and may (for example) be invoked using the Remote Portlet Invocation (“RPI”) protocol. RPI is a remote procedure call approach to portlet execution, whereby stub code resides on the local platform, and this stub code exchanges messages with the remotely-located code, in response to requests made from the local platform, to transparently carry out functions of the remotely-located code.

Once a portlet for each role-specific view has been defined, Block 520 provides linkage between those portlets and the portal aggregation component. Thus, the portal aggregation component can map between the user role and the corresponding role-specific portlet that is to be invoked for a particular user. In preferred embodiments, this linkage is provided using a portlet archive (“PAR”) file for each portal aggregation component and its associated role-specific portlets. PAR files are known in the art, and are used to package together information for a collection of related portlets. In preferred embodiments of the present invention, the PAR file is extended by providing elements expressed in the XML Linking (“XLink”) language, where these elements specify how to reference a particular one of the role-specific portlets. The references identify information within the portal aggregation component's descriptor file.

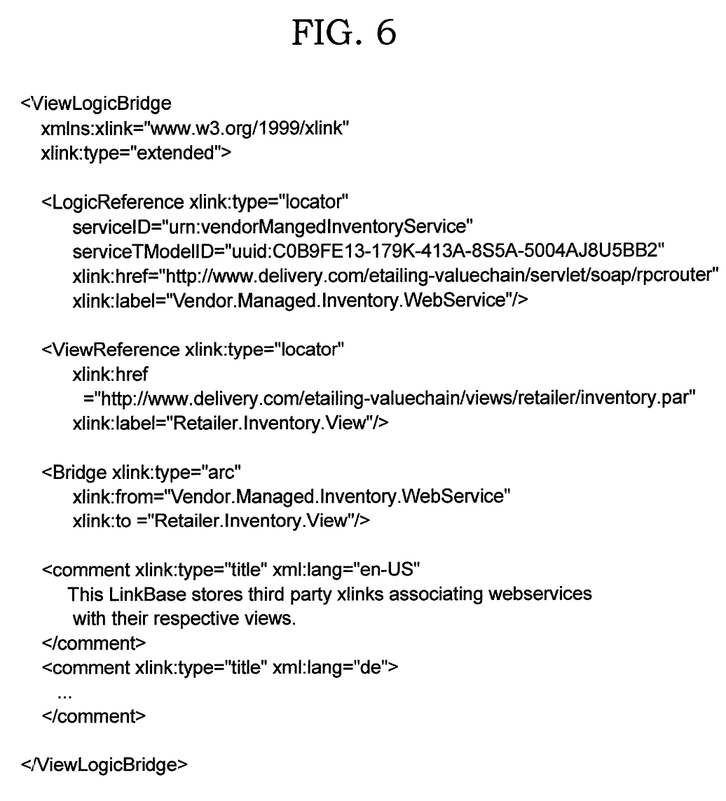

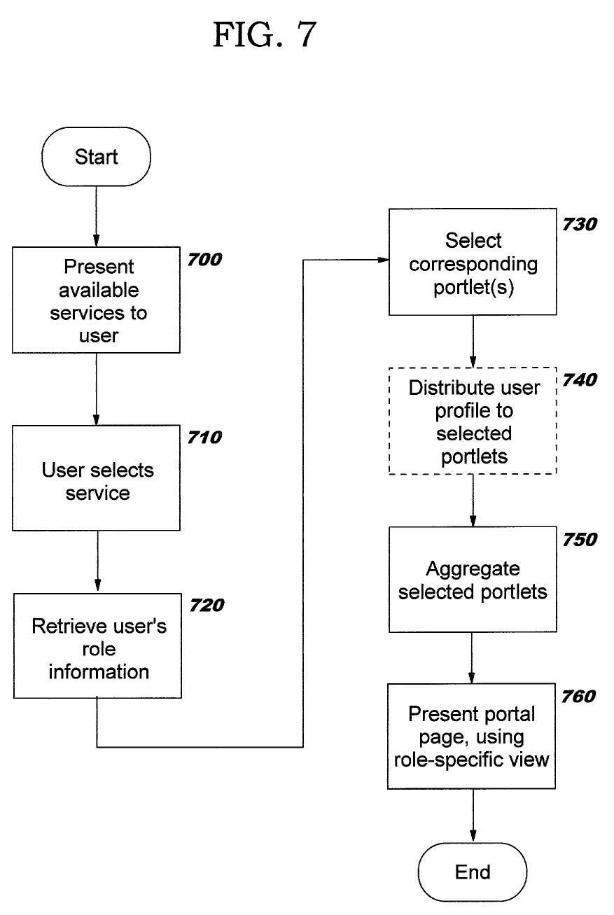

An example illustrating this usage of the XLinking language is shown in FIG. 6. The XLinking language is defined in “XML Linking Language (XLink) Version 1.0, W3C Recommendation Jun. 27, 2001”, which may be found on the Internet at location http://www.w3.org/TR/xlink/.

As is known in the art, XLink syntax may be used to define simple, markup-style links, or more complex links (e.g. links which are bi-directional, links to an unbounded number of resources, third party links, etc.) Third party XLinks associate remote resources, meaning that, although a link or association occurs between a web service or business process and a PAR file, neither resource contains the XLink. This third party XLink approach is shown in the example syntax in FIG. 6. Syntax of this type may be stored in a separate XML document that contains other extended and third party links (i.e. in a linkbase document). In the example, a PAR file is associated with a separate web service. The XLink syntax references this PAR file, which may be a conventional PAR file containing archived portlets and other logic that provide the view for a vendor-managed inventory page. (That is, the linking occurs externally to the PAR file.)

This process of defining portlets for the various role-specific interfaces into a service, and linking those portlets to the portal aggregation component using XLink syntax, may be repeated multiple times. When all the portlets and linkage have been defined/created, the aggregated service has been prepared for role-specific views, and the processing of FIG. 5 ends.

Referring now to the logic in FIG. 7, the process of providing a role-based view for a user at run time begins at Block 700, where a list (or other representation, equivalently) of available services may be presented to the user. Preferably, a registry or other source is consulted to determine which services comprise this list. The user then selects a service from this list (Block 710). (Alternatively, a preselected service might be provided when the user begins interacting with the portal.) Assuming that the selected service is an aggregated service which has been prepared according to the logic in FIG. 5, the selection is mapped to a portal aggregation component defined for that aggregated service, and role-specific views can be programmatically selected once the user's role is known. (Preferably, the mapping between the user's requested service and the portal aggregation component is determined by a Uniform Resource Indicator, or “URI”, which identifies the portal aggregation component.) Block 720 therefore retrieves the user's role information.

As previously described, the user's role is typically determined based on his/her log-on information. When a user logs on to a content framework such as WPS, the user typically provides an identifier and some type of credentials (such as a password). This information can be used to authenticate the user, and optionally to determine the user's access rights, as described in the provisioning invention. The function of Block 720 therefore preferably comprises looking up this user's information in a directory or other repository, and retrieving an identification of the user's role from that repository. Preferably, SOAP messages are used to request the role information from the repository, and the response is preferably delivered using a SOAP message which specifies the user role in a header of the message. The body of the message preferably identifies that this message is delivering the user role. In this manner, the user role information can be programmatically relayed among distributed services performed by the software resources of the aggregated service. (Techniques for exchanging requests and responses using SOAP messages and message headers are well known in the art, and a detailed description thereof is not deemed necessary to an understanding of the present invention.)

Once the user's role is determined, the role is used to select which of the collection of role-specific portlets supported by this portal aggregation component should be provided to this user (Block 730). This selection operation preferably uses the XLink statements which were created in Block 520 of FIG. 5. Preferably, the role-specific sub-services for the entire path through the directed graph are selected at this point, such that the selected sub-services can be aggregated (Block 750) prior to execution of the composite service.

The user's profile information may then optionally be distributed to the selected role-specific portlet(s), as shown in Block 740. This may be useful, for example, to allow personalization of the role-specific views using preferences which may be obtained from the user's profile.

The selected sub-services are then aggregated (Block 750), providing a role-specific view into the composite service for this user, and a portal page which provides an entry point into the composite service is then presented to the user (Block 760).

As has been demonstrated, the present invention provides advantageous techniques for providing role-specific views into aggregated web services. SOAP headers are preferably used to relay user role/profile information. The disclosed techniques enable heterogeneous user profiles to be joined in the dynamic, run-time integration environment of web services. Open standards are leveraged. Note that while particular standards (such as WSFL, SOAP, and XLink) have been referenced when describing preferred embodiments, this is for purposes of illustrating the inventive concepts of the present invention. Alternative means for providing the analogous functionality may be used without deviating from the scope of the present invention.

As will be appreciated by one of skill in the art, embodiments of the present invention may be provided as methods, systems, or computer program products. Accordingly, the present invention may take the form of an entirely hardware embodiment, an entirely software embodiment, or an embodiment combining software and hardware aspects. Furthermore, the present invention may take the form of a computer program product which is embodied on one or more computer-usable storage media (including, but not limited to, disk storage, CD-ROM, optical storage, and so forth) having computer-usable program code embodied therein.

The present invention has been described with reference to flow diagrams and/or block diagrams of methods, apparatus (systems), and computer program products according to embodiments of the invention. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a general purpose computer, special purpose computer, embedded processor or other programmable data processing apparatus to produce a machine, such that the instructions, which execute via the processor of the computer or other programmable data processing apparatus, create means for implementing the functions specified in the flow diagram flow or flows and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flow diagram flow or flows and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flow diagram flow or flows and/or block diagram block or blocks.

While the preferred embodiments of the present invention have been described, additional variations and modifications in those embodiments may occur to those skilled in the art once they learn of the basic inventive concepts. Therefore, it is intended that the appended claims shall be construed to include both the preferred embodiment and all such variations and modifications as fall within the spirit and scope of the invention.

What is claimed is:

1. A method of providing role-specific views of an aggregated service in a computing network, the aggregated service comprising one or more software resources, the method comprising steps of:
providing a role-specific portlet for each role supported by a particular one of the one or more software resources;
providing linkage between the role-specific portlets and the roles for the particular one of the software resources;
repeating the providing steps for each of the one or more software resources;
obtaining, at run time, a user role corresponding to a user of the aggregated service; and
using the obtained role to programmatically select a corresponding one of the role-specific portlets for each of the software resources, thereby providing the role-specific view of the aggregated service.

2. The method according to claim 1, further comprising the step of rendering the selected role-specific view for the user.

3. The method according to claim 1, where in the using step further comprises steps of:
determining which of the one or more software resources should be invoked to position the user's entry point into the aggregated service; and
using the obtained role to programmatically select a role-specific view of the determined software resource.

4. The method according to claim 1, wherein the user role is stored in a user profile associated with the user.

5. The method according to claim 1, wherein the user role is determined using the user's identification and credentials.

6. The method according to claim 1, wherein user role information is programmatically relayed among distributed services performed by the software resources of the aggregated service.

7. The method according to claim 6, wherein the programmatic relaying comprises sending a message which specifies the user role in a header of the message and in which a body of the message identifies that this message is delivering the user role.

8. The method according to claim 7, wherein the message is a SOAP (“Simple Object Access Protocol”) message.

9. The method according to claim 1, wherein the linkage uses XML Linking language (“XLink”) syntax.

10. The method according to claim 1, wherein the linkage is stored in a portlet archive (“PAR”) file.

11. A system for providing role-specific views of an aggregated service in a computing network, the aggregated service comprising one or more software resources, the system comprising:
means for providing a role-specific portlet for each role supported by a particular one of the one or more software resources;
means for providing linkage between the role-specific portlets and the roles for the particular one of the software resources;
means for repeating, for each of the one or more software resources, operation of the means for providing;
means for obtaining, at run time, a user role corresponding to a user of the aggregated service; and
means for using the obtained role to programmatically select a corresponding one of the role-specific portlets for each of the software resources, thereby providing the role-specific view of the particular software resource.

12. A computer program product for providing role-specific views of an aggregated service in a computing network, the aggregated service comprising one or more software resources, the computer program product embodied on one or more computer-readable media and comprising:
computer-readable program code means for providing a role-specific portlet for each role supported by a particular one of the one or more software resources;
computer-readable program code means for providing linkage between the role-specific portlets and the roles for the particular one of the software resources;
computer-readable program code repeating, for each of the one or more software resources, operation of the computer-readable program code means for providing;
computer-readable program code means for obtaining, at run time, a user role corresponding to a user of the aggregated service; and
computer-readable program code means for using the obtained role to programmatically select a corresponding one of the role-specific portlets for each of the software resources, thereby providing the role-specific view of the aggregated service.

13. A method of providing role-specific views from a business web content aggregation framework, the method comprising steps of:
aggregating components from one or more content aggregation frameworks;
providing a role-specific version of at least one of the aggregated components, for each role supported by the at least one aggregated component;
providing linkage between the role-specific versions and the supported roles;
determining a user role corresponding to a current user of the aggregated components;
using the determined user role to programmatically select a corresponding one of the role-specific versions of the at least one aggregated component; and
rendering the programmatically-selected version of the at least one aggregated component, thereby providing the role-specific view.
